(19) United States
(12) Patent Application Publication
(10) Pub. No.: US 2009/0064151 A1
(43) Pub. Date: Mar. 5, 2009

(54) METHOD FOR INTEGRATING JOB EXECUTION SCHEDULING, DATA TRANSFER AND DATA REPLICATION IN DISTRIBUTED GRIDS

(75) Inventors: Vikas Agarwal, Noida (IN); Gargi B. Dasgupta, New Delhi (IN); Koustuv Dasgupta, New Delhi (IN); Amit Purohit, New Delhi (IN); Balaji Viswanathan, New Delhi (IN)

Correspondence Address: CANTOR COLBURN, LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/846,197

(22) Filed: Aug. 28, 2007

(51) Int. Cl. G06F 9/46

(52) U.S. Cl. 718/102

(57) ABSTRACT

Scheduling of job execution, data transfers, and data replications in a distributed grid topology are integrated. Requests for job execution for a batch of jobs are received, along with a set of job requirements. The set of job requirements includes data objects needed for executing the jobs, computing resources needed for executing the jobs, and quality of service expectations. Execution sites are identified within the grid for executing the jobs based on the job requirements. Data transfers needed for providing the data objects for executing the batch of jobs are determined, and data for replication is identified. A set of end-points is identified in the distributed grid topology for use in data replication and data transfers. A schedule is generated for data transfer, data replication and job execution in the grid in accordance with global objectives.

### BACKGROUND

The present invention relates job scheduling and, more particularly, to integration of job execution scheduling, data transfer, and data replication in distributed grids.

Grid computing is a form of distributed computing in which the use of several resources (computing resources, storage, application, and data) are spread across geographic locations and administrative domains. In a service-oriented grid, several heterogeneous cluster sites are interconnected by, e.g., WAN routers and links. The grid hosts customer data and provide computing capabilities. Each customer application (job) is charged for the use of computing and storage resources.

Utility computing has emerged as a promising computing model. With a utility grid, dollars and resources are not tied up in hardware and administrative costs. Rather, the focus is shifted to more strategic aspects, such as Service Level Agreements (SLAs). These agreements specify Quality of Service (QoS) based pricing polices for applications requiring access to computing and data resource and enable grid customers to delineate and prioritize business deliverables.

Traditional service-oriented grid solutions have inherently decoupled the execution of jobs from data transfer (and placement) decisions. A job execution service typically handles the scheduling of a batch of jobs at different compute sites. The choice of a site for each job depends upon factors like load on the site, availability of datasets locally, etc. Multiple transfers of the same data object are avoided by creating replicas of the object at selected sites. The data replication service of the grid provides this functionality. But, most of the time, the replication service is used without tight coordination with the job execution service.

Decoupling execution assignment from data transfer (and replication) often leads to poor and in-efficient response time for jobs. Many aspects of data transfers are not included in the execution scheduling process. Examples of data transfer considerations not currently included in execution scheduling include when and from where should data be transferred, how execution and data transfers can be parallelized, and at what sites data should be placed (replicated) so that the jobs can start executing earlier. Thus, the existing solutions are piecemeal and insufficient for utility grids.

Since the finish time of jobs translates directly to dollars earned or lost, it is very critical to consider both the execution and transfer times of each job. To do so, job execution service needs to work in close co-ordination with the data transfer and data replication services.

### SUMMARY

According to an exemplary embodiment, a method is provided for integrating scheduling of job execution, data transfers, and data replications in a distributed grid topology. The method comprises receiving requests for job execution for a batch of jobs, the requests including a set of job requirements. The set of job requirements includes a set of data objects needed for executing the jobs, a set of computing resources needed for executing the jobs, and quality of service expectations. The method further comprises identifying a set of execution sites within the grid for executing the jobs based on the job requirements, determining data transfers needed for providing the set of data objects for executing the batch of jobs; and identifying data for replication for providing data objects to reduce the data transfers needed to provide the set of data objects for executing the batch of jobs. The method further comprises identifying a set of end-points in the distributed grid topology for use in data replication and data transfers and generating a schedule for data transfer, data replication and job execution in the grid in accordance with global objectives.

### DESCRIPTION OF THE DRAWINGS

Referring to the exemplary drawings, wherein like elements are numbered alike in the several Figures:

FIG. 1 illustrates a system architecture in which job execution scheduling, data transfer, and data replication in distributed grids may be integrated according to an exemplary embodiment;

FIG. 2 illustrates a method for integrating job execution scheduling, data transfer, and data replication in distributed grids according to an exemplary embodiment;

FIG. 3 illustrates an example of an integration scenario according to an exemplar embodiment.

### DETAILED DESCRIPTION

According to exemplary embodiments, a system for Data replication and Execution CO-scheduling (DECO), performs a method for integrating scheduling of job execution, data transfers, and data replication in a grid topology. A DECO system decides which job to assign to which site in the grid, which objects to replicate at which site, when to execute each job, and when to transfer (or replicate) data across the sites. All these decision processes are tightly integrated in the DECO system, which allows for dynamic replication of “beneficial” data objects, co-ordinates the placements of jobs and data objects, and is adaptive to workload changes. According to an exemplary embodiment, job response times are reduced and service profits are increased by integrating scheduling of job execution, data transfer, and data replication.

According to an exemplary embodiment, given a set of jobs and some initial placement of data objects, a schedule for execution of jobs is generated, data objects are transferred, and new replicas are created. Replication considerations include deciding when to create additional replicas, deciding what objects should be replicated, and deciding where to create these additional replicas. Transfer considerations include deciding when to transfer a data object and deciding where to transfer a data object from. Integration with compute scheduling involves finding the compute assignment such that total time to complete job execution is minimized considering data transfer time.

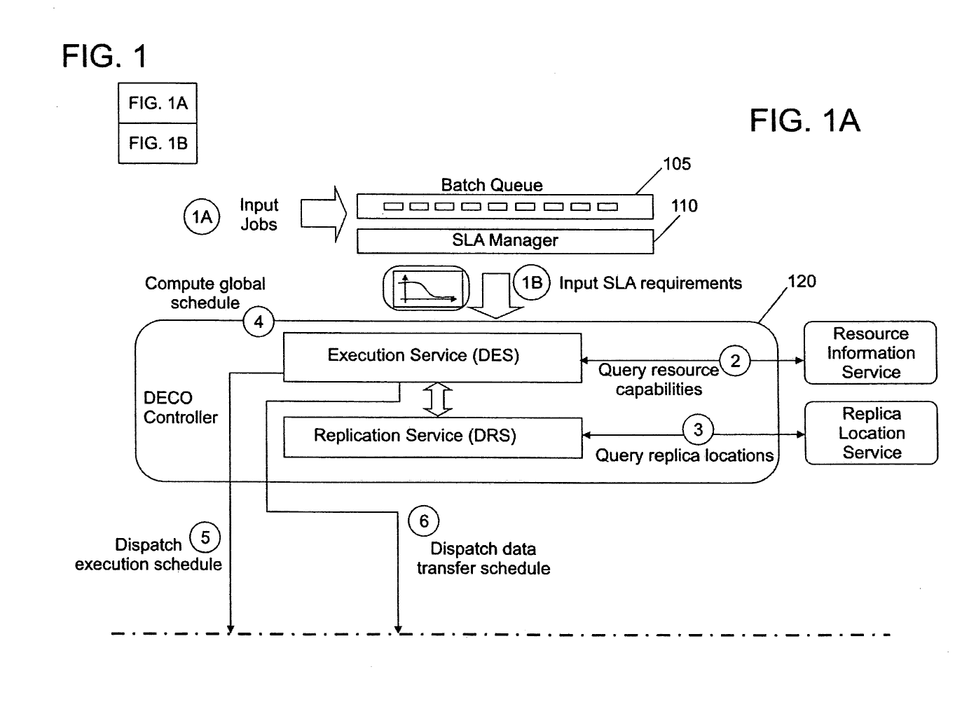

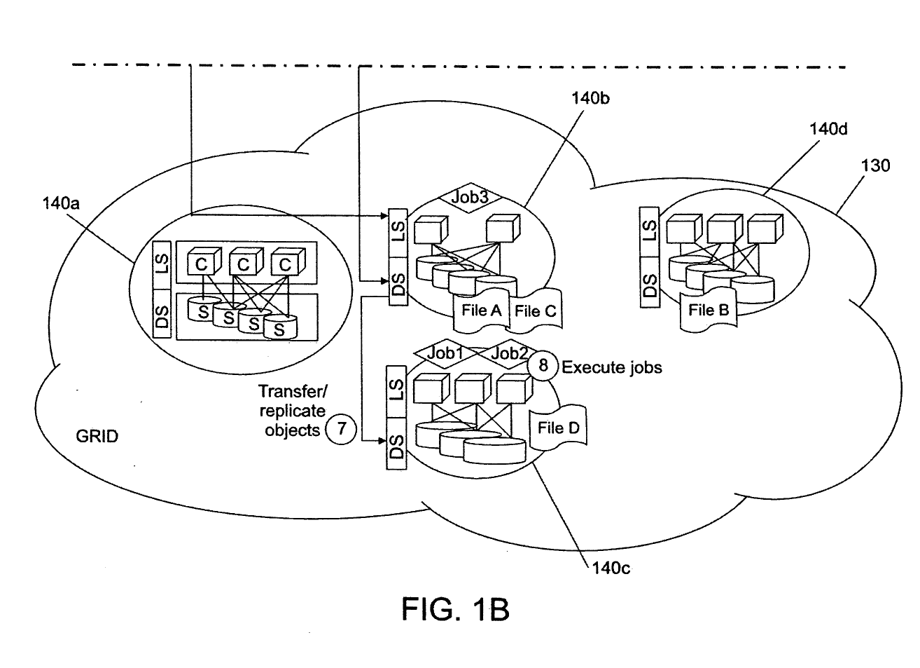

According to an exemplary embodiment, a co-scheduling framework is provided for integrating the execution and data transfer times of compute and data-intensive applications in grids. FIG. 1 illustrates a detailed flow of an integrated job scheduling process through system architecture according to an exemplary embodiment. Referring to FIG. 1, a batch of grid jobs is input, along with computing and data requirements, and SLA descriptions (1A, 1B). A Service Level Agreement (SLA) Manager 10 maintains the revenue functions of each job (derived from the SLA and represented by the graph in FIG. 1). Jobs are admitted to the system via an admission controller that consults, e.g., business policies, customer reputation, current state of system, etc., to admit or reject jobs. Once a job is admitted, it is added to the list of jobs in the Batch Queue 105 to be serviced.

The DECO Controller 120 manages execution of all unfinished jobs, such that business goals are attained. It acts as a single point of submission for all jobs and computes an off-line schedule periodically (e.g., every 24 hrs) for all jobs in the queue. The DECO Controller 120 works on the following assumptions: every job needs to execute at one cluster site, all the data objects needed by a job should be present at its execution site, and jobs are independent and have no dependencies on other jobs.

The DECO Controller 120 includes an Execution Service (DES) and a Replication Service (DRS). There exists a tight integration between the functionalities of these components. The DES gathers resource availability information from a Resource Information Service (2). The DRS gathers location information from a Replica Location Service (3). Depending on the utility values of jobs and the cost benefits obtained from replication, the DES, in conjunction with the DRS, advises job execution sites and replica creation activities of popular objects. Once the decision is made as to where jobs will be executed and what data is to be placed where, the DECO Controller 120 uses its global view of the grid topology and computes a master schedule containing an ordered sequence of replication, data transfer, and execution events across clusters (4). From the master schedule, the DECO Controller extracts the corresponding cluster-specific schedule and dispatches it (5, 6) to each cluster site 140a, 140b, 140c, and 140d in the grid topology 130. The boxes labeled “C” in FIG. 1 refer to compute elements (e.g., server/computer systems), and the boxes labeled “S” refer to storage elements (e.g., a disk) in the cluster. Although four cluster sites are shown for purposes of illustration, it should be appreciated that a grid may contain any number of cluster sites.

At each cluster site, there is a local job scheduler (LS) responsible for intra-cluster job scheduling and management of resources and a data scheduler (DS) responsible for handling data transfers to and from the site. The sequence in which the data transfers and executions happen at the cluster site is determined by the DECO Controller. However, the local job and data schedulers have the autonomny to perform resource allocation for the execution of jobs (8) and transfer/replication of objects (7) using their own scheduling policies. Upon completion of a job, an indication is sent back to the DECO Controller 120.

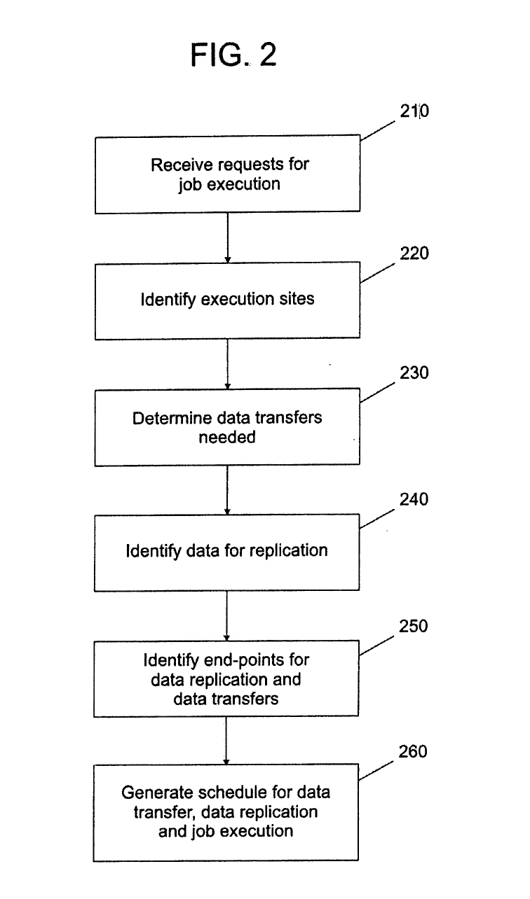

FIG. 2 illustrates a method for integrating scheduling of job execution, data transfer, and data replication according to an exemplary embodiment. At step 210, requests for job execution are received along with job requirements. The job requirements include a set of data objects needed for executing the jobs, a set of computing resources needed for executing the jobs, and quality of service expectations. At step 220, execution sites are identified within the grid for executing the jobs based on the job requirements. At step 230, data transfers needed for providing the set of data objects for executing the jobs are determined. At step 240, data for replication is identified for providing data objects to reduce the data transfers needed to provide the set of data objects for executing the batch of jobs. At step 250, end-points in the distributed grid topology for use in data replication and data transfers are identified. At step 260, a schedule is generated for data transfer, data replication and job execution in the grid in accordance with global objectives.

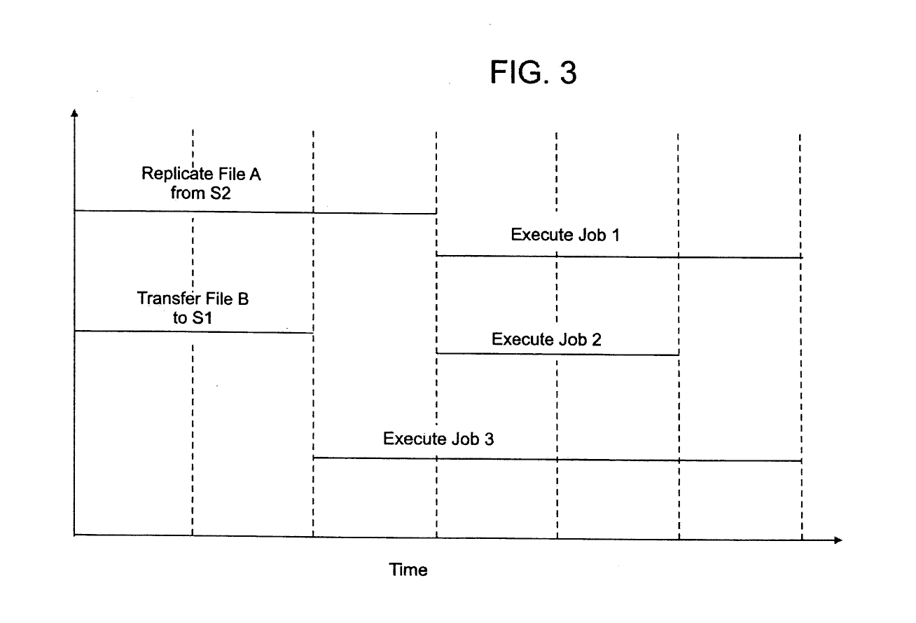

FIG. 3 illustrates an example of a scenario for integrating scheduling of job execution, data transfers, and data replication over time according to an exemplary embodiment. FIG. 3 shows a representative master schedule that the DECO Controller 120 computes for a site, e.g., S1. FIG. 3 shows how different activities of data staging and job execution are placed along the time intervals.

For this example, assume that there are three jobs (Job 1, Job 2, and Job 3) that have been scheduled to run on site S1. Further assume that Job 1 needs File A to execute, Job 2 needs File A and File B to execute, and Job 3 needs File B to execute. The files need to be staged, i.e., transferred into and made available, in at site S1 before each job can begin execution.

DECO's master schedule shows that the DECO Controller has decided to transfer File A to S1 and replicate it at S1. As represented in FIG. 3, the source for File A for the file transfer is site S2. By replicating the File A at S1, a persistent copy of File A is made available to later jobs needing File A and executing at S1. Also, the schedule shows that File B will be transferred from S2 but not replicated at S1. Thus, File B is temporarily stored at S1, and any other job needing the file will need to re-transfer it.

Based on these data staging decisions, the jobs are started. Accordingly, Job 1 starts immediately after replications of File A is completed. Job 2 starts after replication of File A and transfer of File B is completed. Job 3 starts immediately after transfer of File B. It should be noted that the reason why the DECO Controller 120 decides to replicate File A and not File B may be because more jobs require File A, and hence it will be more profitable to make a persistent copy of File A.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for integrating scheduling of job execution, data transfers, and data replications in a distributed grid topology, comprising the steps of:
receiving requests for job execution for a batch of jobs, the requests including a set of job requirements, wherein the set of job requirements includes a set of data objects needed for executing the jobs, a set of computing resources needed for executing the jobs, and quality of service expectations;
identifying a set of execution sites within the grid for executing the jobs based on the job requirements;
determining data transfers needed for providing the set of data objects for executing the batch of jobs;
identifying data for replication for providing data objects to reduce the data transfers needed to provide the set of data objects for executing the batch of jobs, wherein the step of identifying data for replication is performed based on current replica information in the grid topology, estimated cost savings obtained by creating a replica at an additional site, availability of storage for holding a replica at a site, and other constraints stipulated by global objectives;
identifying a set of end-points in the distributed grid topology for use in data replication and data transfers, wherein the step of identifying the set of end-points in the grid topology for use in the data transfer and data replications comprises determining a set of remote sites from which to transfer data objects and determining a set of remote links along which to transfer the data objects; and
generating a schedule for data transfer, data replication and job execution in the grid, wherein the step of generating a schedule for data transfers, data replication, and job execution comprises estimating time to complete each data transfer, data replication, and job execution, determining how to perform data transfers, data replication, and job execution in parallel in such a manner that system constraints are not violated, and determining an ordering of job executions, data transfers, and data replications such that the global objectives are satisfied in accordance with the global objectives.

2-5. (canceled)
